(19) United States
(12) Patent Application Publication
(10) Pub. No.: US 2025/0351080 A1
(43) Pub. Date: Nov. 13, 2025

(54) METHODS, ARCHITECTURES, APPARATUSES AND SYSTEMS FOR AGGREGATED PHYSICAL LAYER PROTOCOL DATA UNIT (A-PPDU) WITH WAKE-UP RADIO (WUR) SIGNALS IN WI-FI

(71) Applicant: InterDigital Patent Holdings, Inc., Wilmington, DE (US)

(72) Inventors: Ying WANG, Easton, PA (US); Hanqing Lou, Syosset, NY (US); Rui Yang, Greenlawn, NY (US); Mahmoud Saad, L'Ile Bizard (CA)

(21) Appl. No.: 18/660,755

(22) Filed: May 10, 2024

(51) Int. Cl. H04W 52/02; H04L 27/02; H04L 27/26

(52) U.S. Cl. CPC H04W 52/0235; H04L 27/02; H04L 27/2603

(57) ABSTRACT

Procedures, methods, architectures, apparatuses, systems, devices, and computer program products for aggregated physical layer protocol data unit (A-PPDU) with wake-up radio signals in Wi-Fi. One method may include receiving, from an access point (AP), a frame including a wakeup radio (WUR) operation parameter field having an aggregated physical protocol packet data unit (A-PPDU) subfield. The method may include receiving, from the AP, an aggregated physical protocol data unit (A-PPDU) including a first non-WUR PPDU and/or a first WUR PPDU based on information indicated in the A-PPDU subfield.

### FIELD

Example embodiments described in the present disclosure are generally directed to the fields of communications, software and/or encoding, including, for example, to methods, architectures, apparatuses, systems related to the operation and/or handling of traffic with wake-up radio (WUR) signals in Wi-Fi.

### BACKGROUND

Low power devices may be used in a number of applications and Internet-of-Things (IoT) use cases. For example, such use cases may include healthcare, smart home, industrial sensors, wearables, etc. Devices used in these applications are usually powered by a battery. Prolonging the battery lifetime while also maintaining low latency becomes an important objective. Hence, it is desirable for power efficient mechanisms be used with battery-operated devices while maintaining low latency where it is required. For instance, a typical frequency domain multiple access (FDMA) active receiver may consume tens to hundreds of milliwatts. To further reduce power consumption, devices can use power save modes. Devices based on the IEEE 802.11 power save modes periodically wake up from a sleep state to receive information from an access point (AP) and to know if there are data to receive from the AP. The longer the devices stay in the sleep state, the lower power the devices consume but at the expense of increased latency of data reception.

### SUMMARY

An example embodiment may be directed to a method, which may be implemented by a STA, and includes receiving, from an access point (AP), a frame including a wakeup radio (WUR) operation parameter field having an aggregated physical protocol packet data unit (A-PPDU) subfield. The method may include receiving, from the AP, an aggregated physical protocol data unit (A-PPDU) including any of a first non-WUR PPDU and a first WUR PPDU based on information indicated in the A-PPDU subfield.

An example embodiment may be directed to a method, which may be implemented by an AP, and includes generating a first non-wakeup radio (WUR) physical layer protocol data unit (PPDU) having a first legacy and non-legacy preamble, generating a first WUR PPDU having a second legacy and non-legacy preamble, and transmitting the first non-WUR PPDU and the first WUR PPDU as an aggregated physical protocol data unit (A-PPDU).

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example of a wireless local area network (WLAN) having enhanced aggregate physical protocol data unit (A-PPDU) capabilities, according to an embodiment;

FIG. 3 illustrates an example of the WUR physical layer protocol data unit (PPDU), according to an embodiment;

FIG. 4 illustrates an example of a WUR frequeny domain multiple access (FDMA) PPDU, according to an embodiment;

FIG. 5 illustrates an example of aggregation of WUR signals with UHR PPDUs in 20 MHz subchannels over an 80 MHz bandwidth, according to an example embodiment;

FIG. 6 illustrates a transmit spectrum mask for WUR-Sync and WUR-Data fields of WUR basic PPDU transmission, according to an embodiment;

FIG. 7 illustrates an example of the transmission of an A-PPDU, according to an embodiment;

FIG. 8 illustrates another example of aggregation of WUR PPDUs in a 20 MHz subchannel, according to an embodiment;

FIG. 9 illustrates an example of aggregating WUR PPDU with UHR PPDU, according to an embodiment;

FIG. 10 illustrates an example of RU allocation in a 20 MHz subchannel aggregating WUR signals, according to an embodiment;

FIG. 11 illustrates an example of aggregating WUR signals with UHR PPDUs, according to an embodiment;

FIG. 12 illustrates another example of aggregating WUR signals with UHR PPDUs, according to an embodiment;

FIG. 13 illustrates an example of aggregating WUR signals with UHR PPDUs, according to an embodiment

FIG. 14 illustrates another example of aggregating WUR signals with UHR PPDUs, according to an embodiment;

FIG. 15 illustrates an example of aggregating WUR signals with UHR PPDUs, according to another embodiment;

FIG. 16 illustrates an example flow chart of a method, according to an embodiment;

FIG. 17 illustrates an example WUR Capabilities element, according to an embodiment;

FIG. 18 illustrates an example of a modified Supported Bands field in the WUR capabilities element, according to an embodiment;

FIG. 19 illustrates an example modified WUR Capabilities Information field format, according to an embodiment;

FIG. 20 illustrates an example of the WUR operation element, according to an embodiment;

FIG. 21 illustrates a WUR Operation Parameters field with an A-PPDU subfield, according to an embodiment;

FIG. 22 illustrates the WUR Mode element format, according to an embodiment;

FIG. 23 illustrates a WUR Parameters Control field, according to an embodiment;

FIG. 24 illustrates a WUR Parameters field, according to an embodiment;

FIG. 25 illustrates a WUR Group ID List/WUR Channel Indication subfield, according to an embodiment;

FIG. 26A illustrates a flow diagram of a method, according to an embodiment;

FIG. 26B illustrates a flow diagram of a method, according to an embodiment; and

FIG. 27 illustrates a flow diagram of a method, according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

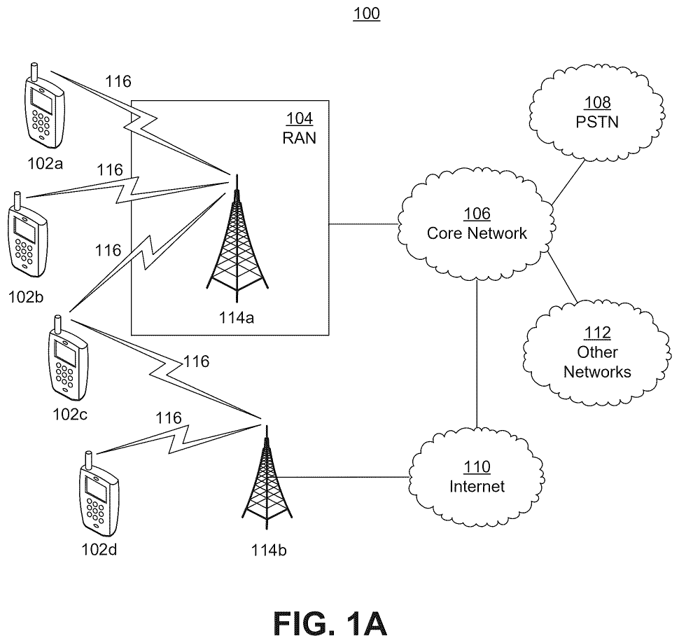

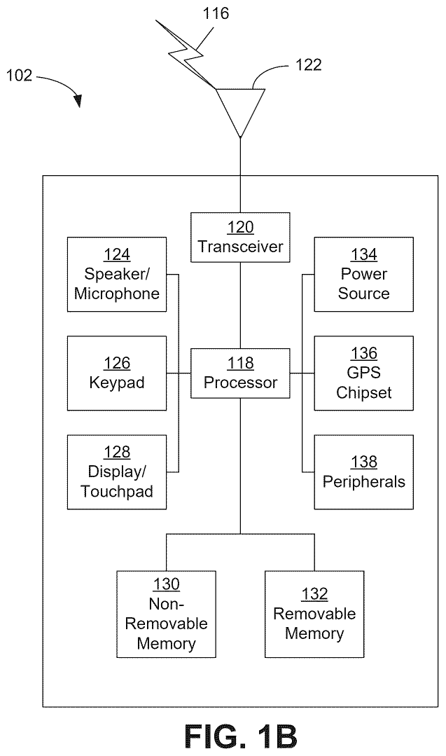

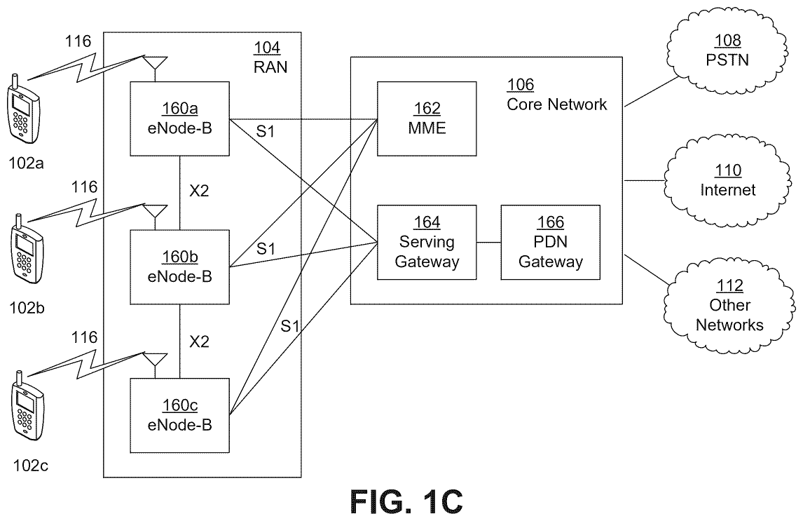

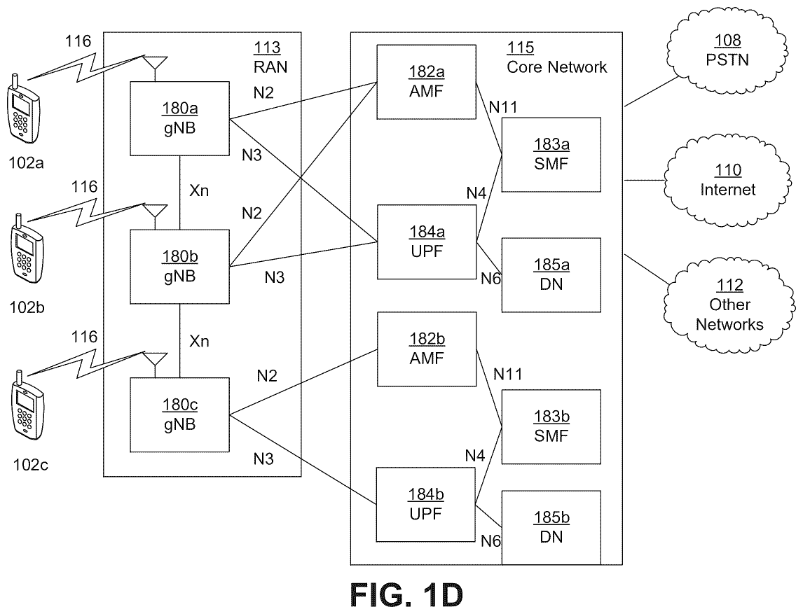

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d, or any other WTRU mentioned or described herein, may be interchangeably referred to as a UE or vice versa.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing an NR radio technology, the CN 106 may also be in communication with another RAN (not shown) employing any of a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements or peripherals 138, which may include one or more software and/or hardware modules or units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor, and the like.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP (e.g., See IEEE Std 802.11™-2020: Wireless LAN Medium Access Control (MAC) and Physical Layer (PHY) Specifications [1]). The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHz, 80 MHz, and/or 160 MHz wide channels transmitted over a 5 GHz frequency band using OFDMA (e.g., See IEEE P802.11ax™/D8.0: Wireless LAN Medium Access Control (MAC) and Physical Layer (PHY) Specifications [2]). The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHz, 80 MHz, and/or 160 MHz wide channels capable of transmission over 2.4 GHz, 5 GHz, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHz and 6 GHz) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

Sub 1 GHz modes of operation are supported by 802.11af and 802.11ah (e.g., See IEEE P802.11-REVme™/D5.0, Wireless LAN Medium Access Control (MAC) and Physical Layer (PHY) Specifications, February 2024 [3]). For these specifications the channel operating bandwidths, and the number of OFDM subcarriers, are reduced relative to those used in 802.11n and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. A possible use case for 802.11ah is support for Meter Type Control (MTC) devices in a macro coverage area. MTC devices may have limited capabilities with limited bandwidths, but they may require a very long battery life.

WLAN systems that support multiple channels and channel widths, such as 802.11n, 802.11ac, 802.11af, 802.11ah, 802.11ax, and 802.11be, include a channel that is designated as the primary channel. The primary channel may, but not necessarily, have a bandwidth equal to the largest common operating bandwidth supported by all STAs in the BSS. The bandwidth of the primary channel may therefore be limited by the STA that supports the smallest bandwidth operating mode in the BSS. In the example of 802.11ah, the primary channel may be 1 MHz wide if there are STAs (e.g., MTC type devices) that only support a 1 MHz mode even if the AP, and other STAs in the BSS, may support 2 MHz, 4 MHz, 8 MHz, 16 MHz, or other channel bandwidth operating modes. The carrier sensing and NAV settings depend on the status of the primary channel, i.e., if the primary channel is busy, for example, due to a STA supporting only a 1 MHz operating mode is transmitting to the AP, then the entire available frequency bands may be considered busy even though majority of it stays idle and available.

The next generation of 802.11 standard, 802.11bn (i.e., Ultra High Reliability—UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave—IMMW), energy harvesting based on of WiFi RF signals for facilitating WLAN communications of low-power IoT devices, and the randomization of MAC addresses in WLANs.

Embodiments disclosed herein are representative and do not limit the applicability of the apparatus, procedures, functions and/or methods to any particular wireless technology, any particular communication technology and/or other technologies. The term network in this disclosure may generally refer to one or more base stations or gNBs or other network entity which in turn may be associated with one or more Transmission/Reception Points (TRPs), or to any other node in the radio access network.

It is noted that, throughout example embodiments described herein, the terms “base station”, “seving base station”, “RAN,” “RAN node,” “Access Network,” “NG-RAN,” “gNodeB,” and/or “gNB” may be used interchangeably to designate any network element such as, e.g., a network element acting as a serving base station. It should be understood that embodiments described herein are not limited to gNBs and are applicable to any other types of base stations.

Low power devices manifest themselves in a number of applications and/or Internet-of-Things (IoT) usage cases. These use cases may include healthcare, smart home, industrial sensors, wearables, etc. Devices used in these applications are usually powered by a battery. Prolonging the battery lifetime while in some use cases also maintaining low latency is desirable. Power efficient mechanisms need to be used with battery-operated devices while maintaining low latency where it is required. A typical OFDM active receiver consumes tens to hundreds of milliwatts. To further reduce power consumption, devices use power save modes. Devices based on the IEEE 802.11 power save modes periodically wake up from a sleep state to receive information from an access point (AP) and to know if there are data to receive from the AP. The longer the devices stay in the sleep state, the lower power the devices consume but at the expense of increased latency of data reception. Given the limitation of the above power saving methods, 802.11ba was developed to enable more significant power saving while supporting low-latency traffic.

As specified in the 802.11ba project authorization request (PAR) document (e.g., See IEEE 802.11-16/1045r9, “A PAR Proposal for Wake-up Radio,” July 2016 [4]), 802.11ba defines a physical layer specification and medium access control layer specification that enables operation of a wake-up radio (WUR) for 802.11 devices. The 802.11ba WUR is a companion radio to the primary connectivity radio or the main radio (MR) that supports 802.11 standards such as non-HT, HT, VHT, or HE. The main radio would stay in deep sleep mode most of the time and only turn on to transfer data when the WUR receives a wake-up message. This leads to ultra-low power consumption while supporting low-latency traffic. To serve this purpose, some requirements that are to be satisfied may include: the wake-up frames carry only control information that can trigger a transition of the primary connectivity radio out of sleep; the WUR meets the same range requirement as the primary connectivity radio; the WUR devices coexist with legacy IEEE 802.11 devices in the same band; and/or the WUR has an expected active receiver power consumption of less than one milliwatt.

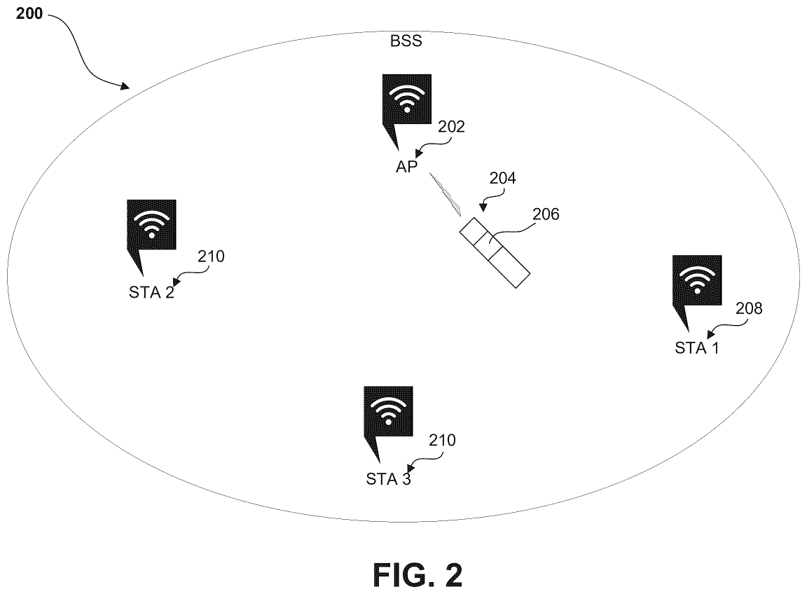

FIG. 2 illustrates an example of a WLAN BSS 200 having enhanced aggregate physical protocol data unit (A-PPDU) capabilities, according to an embodiment. As depicted in the example of FIG. 2, an AP 202 within the BSS 200 may send a frame 204 (e.g., a management frame) that includes a subfield 206 indicating a capability to transmit A-PPDUs that aggregate both one or more wakeup radio (WUR) PPDUs and one or more non-WUR PPDUs (e.g., UHR PPDUs, UHR+ PPDUs, etc.). Based on one or more of the STAs 208, 210, 212 within the BSS 200 indicating their respective capability to process the enhanced A-PPDUs, the AP 202 may transmit A-PPDUs that aggregate both WUR PPDUs and non-WUR PPDUs to these STAs.

For example, STA 210 may not have the capability to receive and process A-PPDUs with aggregated WUR and non-WUR PPDUs. However, STAs 208 and 210 may have indicated their capability to receive and process such A-PPDUs. Accordingly, the AP 202 my send an A-PPDU with aggregated WUR and non-WUR PPDUs to both STA 208 and STA 210. For example, if STA 210 is an Internet of Things (IoT) device, it may receive and process WUR frames within the A-PPDU using its wakeup radio while in power-save mode. On the other hand, STA 208 may be a non-WUR device that receives and processes a non-WUR PPDU portion of the A-PPDU such as a UHR PPDU.

According to other embodiments, the A-PPDU may also facilitate the reception of low latency traffic based on the WUR PPDU. For example, for IoT STA 210, the WUR PPDU may facilitate several features to, among other things, maintain the transmission medium for the STA 210 in order to receive the low latency data without the delay of contending for the medium; wake up the main radio by transitioning from the wakeup radio to the main radio; and/or determine different bandwidths (e.g., one or more resource units (RUs) within a subchannel, across the entire subchannel, or across multiple subchannels) for receiving the low latency data.

Various features are described in more detail in the following example embodiments.

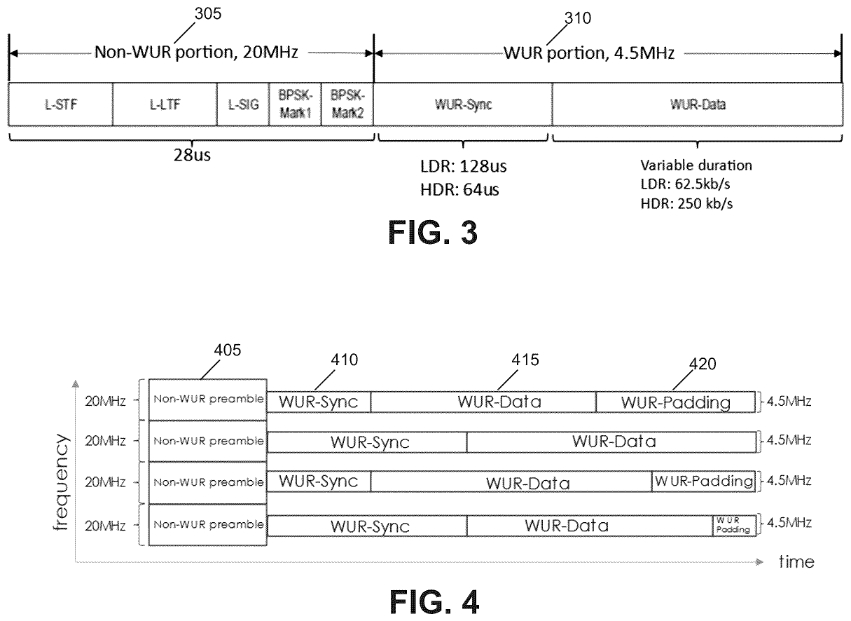

FIG. 3 illustrates an example of the WUR physical layer protocol data unit (PPDU), according to an embodiment. As shown in FIG. 3, the basic 802.11ba PPDU has two portions: the non-WUR portion 305 and the WUR portion 310. The design of the non-WUR portion 305 is influenced by the requirement of coexisting with other 802.11 devices operating in the same frequency band. The non-WUR portion 305 occupies 20 MHz and uses the standard OFDM waveform that can be decoded by non-WUR STAs, so that they recognize the duration of the WUR PPDU and defer to the current WUR transmission. The non-WUR portion 305, with a total duration of 28 us, includes legacy short training fields (L-STF), legacy long training fields (L-LTF), the legacy signal field (L-SIG), and two 802.11ba-defined fields BPSK-Mark1 and BPSK-Mark2. On the other hand, the WUR portion 310 is designed to meet the requirement of enabling the use of ultra-low-power noncoherent receivers. The WUR portion 310 occupies a 4.5 MHz bandwidth and uses the on-off keying (OOK) modulation. The WUR portion 310 includes the synchronization (WUR-Sync) field and the Data (WUR-Data) field. The WUR-Sync field serves several purposes for the WUR receivers, these purposes include: WUR PPDU detection, symbol timing recovery, and identification of the data rate used in the WUR-Data field. The WUR-Data field supports two data rates: the high data rate (HDR) of 250 kb/s and the low data rate (LDR) of 62.5 kb/s. The LDR support may be mandatory while the HDR support is optional. If the WUR-Data field uses the HDR, the HDR WUR-Sync field is comprised of 32 OOK symbols, each of a 2 us duration, with a total duration of 64 us; if the WUR-Data field uses the LDR, the LDR WUR-Sync field is comprised of 64 OOK symbols with a total duration of 128 us. The HDR WUR-Data field uses a simple Manchester encoding scheme to map an information 0 bit to two encoded bits {1, 0} and an information 1 bit to {0, 1}. Each HDR encoded bit has a duration of 2 us. Similarly, the LDR WUR-Data field uses a combination of repetition and Manchester encoding to map an information 0 bit to four encoded bits {1, 0, 1, 0} and an information 1 bit to {0, 1, 0, 1}. Each LDR encoded bit has a duration of 4 us.

The 802.11ba standards support the frequency domain multiple access (FDMA) of multiple WUR signals over 40 MHz and 80 MHz for higher efficiency and lower latency. FIG. 4 illustrates an example of an 80 MHz WUR FDMA PPDU, according to an embodiment. Each WUR signal occupies a 20 MHz channel with the non-WUR preamble portion 405 filling the 20 MHz channel while the WUR Sync field 410 and WUR-Data field 415 is in the middle 4.5 MHz of the 20 MHz channel. The non-WUR preamble portion 405 is duplicated every 20 MHz. A different WUR-Sync field 410 according to the rate of the WUR-Data field 415 may be applied to each 20 MHz subchannel and, to make the transmission duration on each 20 MHz channel the same, padding with OOK symbols (WUR-Padding 320) is added to the shorter duration signals. It is also noted that over the 40 MHz or 80 MHz channels, some 20 MHz subchannels could be punctured, i.e., nothing is transmitted over the punctured channels.

Although the generation of OOK modulated signals is implementation dependent, 802.11ba specification provides examples of methods using OFDM technique to generate such a signal by properly selecting an input sequence in frequency domain (i.e., at the input of IFFT operation) such that the signal in time domain (i.e., the output of the IFFT operation) is an OOK modulated waveform with specified “On” and “Off” durations. Those examples in the 802.11ba specification are based in 802.11ac OFDM numerology design. The choice of the sequence in frequency domain is not unique, but not arbitrary. The OOK waveform implemented using OFDM is named Multi-Carrier OOK (MC-OOK) waveform.

IEEE 802.11 Ultra High Reliability (UHR), or 802.11bn, is considered as the next major revision to IEEE 802.11 standards following 802.11be (High Efficiency Wireless, or HEW). UHR explores the possibility to improve reliability, support further reduced low latency traffic, further increase peak throughput, improve power saving capabilities and improve efficiency of the IEEE 802.11 network over HEW.

To improve power saving capabilities, in addition to the non-HT, HT, VHT, or HE devices (e.g., as specified in IEEE P802.11-REVme™/D5.0, Wireless LAN Medium Access Control (MAC) and Physical Layer (PHY) Specifications, February 2024 [3]), it is desirable to have WUR as a companion radio for EHT and UHR devices too. Such non-AP STAs with WUR receivers may be referred to as WUR STAs and APs with WUR transmitters may be referred to as WUR APs.

Even though the current standards already support the WUR FDMA PPDU format over 40 MHz and 80 MHz channels for better efficiency and lower latency, there is still much room for improvement. In one scenario, there may be simultaneously both low-latency traffic using OFDM signals to non-AP STAs and urgent need to wake up MRs of WUR STAs in deep sleep mode using OOK signals. In another scenario, the traffic to a deep-sleep mode MR may be so urgent that it requires the MR to receive data right after waking up. In yet another scenario, a WUR AP may support 160 MHz or 320 MHZ operation. These scenarios call for better aggregation of OFDM signals with WUR signals in some aggregated PPDU (A-PPDU) format over both frequency and time domains, as provided by some example embodiments discussed in the following.

WUR was defined to support FDMA transmission over a channel with channel bandwidth up to 80 MHz in 802.11ba. For example, a WUR FDMA PPDU may operate on a 40 MHz channel or an 80 MHz channel, where WUR signals for different users may be located on different 20 MHz subchannels within the wideband channel. The newer version of Wi-Fi signals, such as EHT/UHR/UHR+ signals may be transmitted over a wider bandwidth such as 160 MHz and 320 MHz. An EHT/UHR/UHR+ AP that supports WUR operation may want to transmit WUR FDMA PPDU over a wider bandwidth. Moreover, if A-PPDU with WUR signals is supported, it may be more flexible that WUR signals may be located on any 20 MHz subchannel within a wider bandwidth such as 160 MHz or 320 MHz. Thus, procedures are needed to support WUR signal transmission on any 20 MHz subchannel (or wider subchannels) over a wideband PPDU.

As discussed in detail in the following, an embodiment may provide a procedure for urgent wake-up and low-latency traffic, which may be performed or implemented by a WUR AP and/or a WUR STA, where WUR signals in an A-PPDU are received by the WUR of the WUR STA to wake up the main radio of the WUR STA and then low-latency traffic data are received by the main radio.

As discussed in detail in the following, in some embodiments, a WUR AP may transmit A-PPDUs that aggregate WUR signals with other WUR or non-WUR 802.11 signals, e.g., 802.11bn signals or 802.11bn+ signals, in both frequency and time domains. The WUR AP and non-AP STAs in a BSS exchange WUR-related information through the enhanced WUR capabilities element, the enhanced WUR operation element, and the enhanced WUR mode element in Beacom frames, Probe Request/Response frames, (Re)Association Request/Response frames, and/or Action frames. A procedure for urgent wake-up and receipt of low-latency traffic may be implemented or performed by a WUR AP and a WUR STA, as will be discussed below.

It is noted that, in the following, data traffic that uses OFDM modulation signals may be referred to as “UHR signals” or “OFDM signals” or “non-WUR signals”, but it should be understood that such signals can be OFDM signals for UHR or any future 802.11 standards. The same applies for “UHR PPDU” or “non-WUR PPDU”. Also, in the following, the WUR portion of the 802.11ba PPDU format may be referred to as “WUR signals” or “OOK signals” or “WUR PPDU” or “WUR frame”. In addition, in the following, it may be mentioned that the purpose of the WUR signals is to wake-up the MR of the WUR STA, but in some scenarios, the WUR signals may be the WUR portion of a WUR Beacon, Discovery, Wake-up, Short Wake-up, Vendor Specific frame, or the like.

As will be discussed in more detail in the following, some example embodiments may provide or include A-PPDU with WUR signals in frequency domain and time domain.

When a WUR AP transmits simultaneously both UHR data traffic (e.g., OFDM signals) to active STAs and WUR data (e.g., OOK signals) to WUR receivers, a proper packing of signals with different modulation format is needed. Since the WUR OOK signals may not align with the OFDM signals in term of cyclic prefix and symbol boundaries, they may not be orthogonal in the frequency domain to the OFDM signals and hence cause interference to the latter.

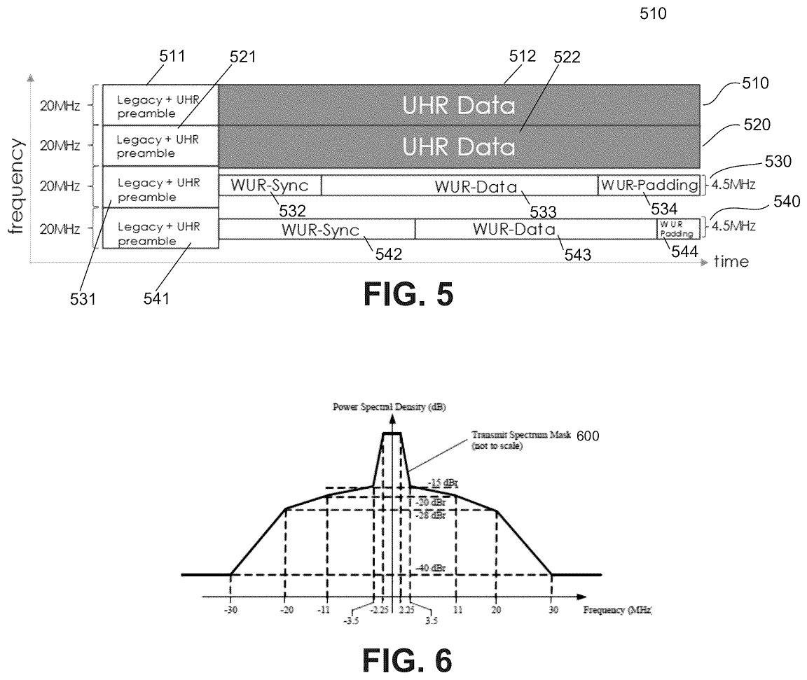

One example packing method is with the granularity of 20 MHz subchannels. For example, FIG. 5 illustrates an example of aggregation of WUR signals with UHR PPDUs in 20 MHz subchannels over an 80 MHz bandwidth, according to an example embodiment. In this example, each 20 MHz subchannel can be intended to transmit data for either WUR receivers only or other non-WUR 802.11 users only, but not mixing both. As illustrated in the example of FIG. 5, non-WUR PPDUs 510, 520 may include a legacy and non-legacy preamble 511, 521 and may include UHR data 512, 522. WUR PPDUs 530, 540 may include a legacy and non-legacy preamble 531, 541, WUR-Sync 532, 542, WUR-Data 533, 543 and WUR-Padding 534, 544. In some embodiments, the legacy and non-legacy preambles 511, 521, 531, 541 may be the same or may be different. It is noted that this is just one example of an aggregation of WUR signals with UHR PPDUs and other examples or modifications are contemplated according to other embodiments.

FIG. 6 illustrates a transmit spectrum mask for WUR-Sync and WUR-Data fields of WUR basic PPDU transmission, according to an embodiment. The transmit spectrum mask refers to the power contained in a specified frequency bandwidth at certain offsets, relative to the total carrier power. As shown in the example of FIG. 6, the spectrum mask 600 of the WUR OOK signal requires the leakage power to fall to −20 dBr when it is 11 MHz away from the center frequency of the OOK signal. Without any change to the WUR OOK signal waveform generation methods, such as those suggested in the 802.11ba standards (e.g., See IEEE P802.11-REVme™/D5.0, Wireless LAN Medium Access Control (MAC) and Physical Layer (PHY) Specifications, February 2024 [3]), this method minimizes the interference of the OOK signals to the OFDM symbol in the adjacent 20 MHz subchannel simply through the natural separation of UHR and WUR signals in spectrum. On the other hand, the transmit spectrum mask of the OFDM signals required by the standards ensures that the interference from the OFDM signals to the OOK signals is also minimized by the natural separation of UHR and WUR signals in spectrum. Therefore, this method of aggregating the WUR PPDUs and the UHR PPDUs does not impose more stringent requirements on the low-pass filter used in the low-cost non-coherent WUR receiver to filter out noise and interference outside of the OOK signal bandwidth for better OOK signal detection. To further reduce the mutual interference between the OFDM and OOK signals, one method is to place the bandwidth occupied by the OOK signal in a 20 MHz subchannel farthest from the adjacent subchannels occupied by the OFDM signals. In the example shown in FIG. 5, the bottom two 20 MHz subchannels are occupied by WUR signals and the center frequency of the two WUR signals could be placed to be close to, say, 2.875 MHz away from, the lower edge of their respective 20 MHz subchannels. This way, the interference from the WUR signals to the UHR signals in the top two 20 MHz subchannels would be lower than −25 dBr.

It should be noted that FIG. 5 provides an illustration of one example of an A-PPDU with WUR signals. The total bandwidth could be generalized to, for example, 40 MHz, 80 MHz, 160 MHz, 320 MHz, or any larger bandwidth that may be defined in future 802.11 standards. One UHR PPDU may span over different combinations of subchannels such as 20 MHz, 40 MHz, 40 MHz+20 MHz, 80 MHz, 80 MHz+20 MHz, 80 MHz+40 MHz, 80 MHz+80 MHz, 160 MHz, 160 MHz+20 MHz, 160 MHz+40 MHz, 160 MHz+80 MHz, and so on. There may be any number of combinations and orderings of UHR PPDUs and WUR PDUs across the whole bandwidth as appropriate.

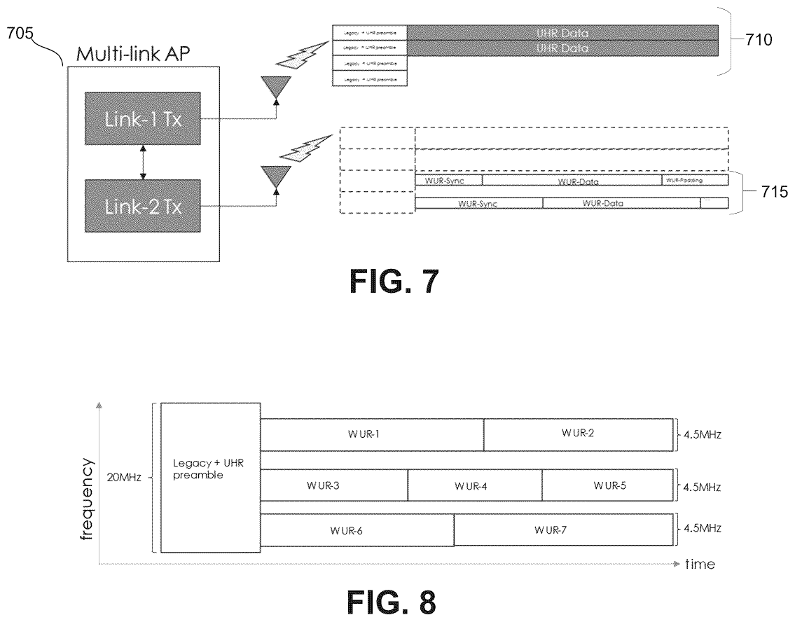

In one embodiment, the transmission of A-PPDUs with both UHR data and WUR signals may be achieved using a multi-link device or multi-link AP with multiple radios. The signals transmitted may be allocated on the same link or channel, each occupying different subchannels. The link that transmits UHR data may send legacy and UHR preambles on all subchannels, while the link that transmits WUR signals may start the transmission after the end of the preambles. FIG. 7 illustrates an example of the transmission of an A-PPDU with UHR 710 and WUR PPDUs 715 by a multi-link AP 705, according to an example embodiment. The allocation of the subchannels and transmission timing relative to a reference point of UHR-PPDU (e.g., the start of the PPDU) for WUR signals may need to be signaled in the UHR preamble. That is, the UHR preamble in a subchannel assigned to WUR signals may need to indicate that a WUR signal will be sent in this subchannel and to signal when the WUR signal transmission will start relative to a timing reference point. This signaling may happen in the U-SIG, or UHR-SIG field of the UHR preamble, for example.

FIG. 8 illustrates another example of aggregation of WUR PPDUs in a 20 MHz subchannel, according to an embodiment. In the example of FIG. 8, in the 20 MHz subchannels that are dedicated to WUR signals, multiple WUR signals (e.g., WUR-1, WUR-2, WUR-3, WUR-4, WUR-5, WUR-6, WUR-7, etc.) for different users may be packed both in time and frequency for higher efficiency. In this case, the AP may need to arrange the frequency spacing among the WUR signals within a 20 MHz subchannel and/or the UHR/WUR signals in adjacent subchannels to minimize mutual interference among signals, taking into consideration factors such as the filtering and detection capabilities of the WUR receivers and the receiving capabilities and/or conditions of the UHR receivers. It is noted that in the example of FIG. 8, each WUR signal (i.e., WUR-1 or WUR-2, . . . , WUR-7) includes WUR-sync, WUR-data and, possibly, WUR-padding portions, and may be used to wake up one or more STAs. In addition, there may be a certain time gap or certain time period between two consecutive WUR signals over the same frequencies (e.g., between WUR-1 and WUR-2). In another example, the first WUR signal (e.g., only the first WUR signal) of each WUR subchannel (i.e., WUR-1, WUR-3, and WUR-6 in FIG. 8) contains WUR-sync, and the subsequent WUR signals contain WUR-data (e.g., contain WUR-data only).

Note that in the case of dedicated 20 MHz subchannels for WUR signals, padding may be needed at the end of a WUR or UHR PPDU so that all the PPDUs across the 20 MHz subchannels in use end at the same time. The packet transmission time may be signaled in the LENGTH bits of the L-SIG field in the preamble.

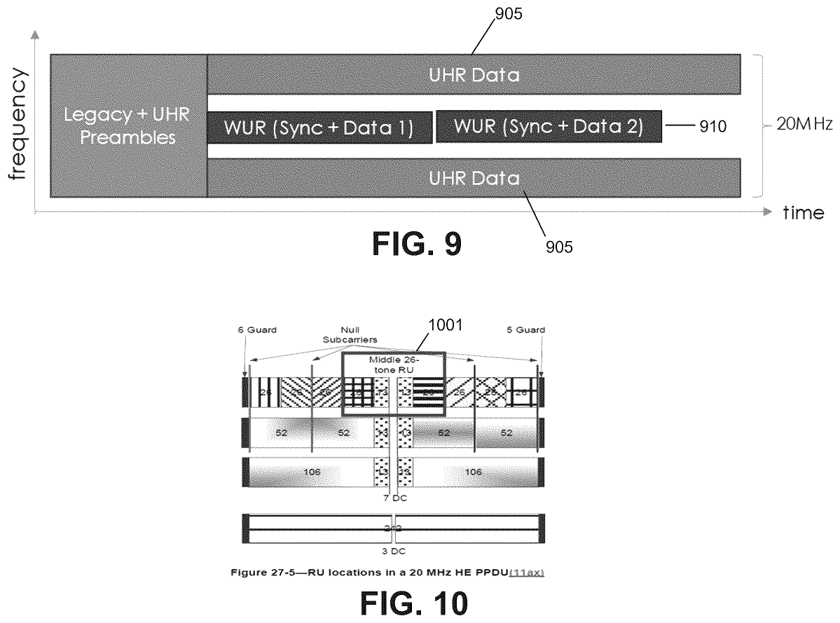

Another efficient method is packing with the granularity of resource units (RUs), where the AP allocates some RUs to the WUR signals and other RUs to the UHR signals. FIG. 9 illustrates an example of aggregating WUR PPDU with UHR PPDU, according to an embodiment. As shown in the example of FIG. 9, in this 20 MHz subchannel example, instead of dedicating the whole 20 MHz subchannel to a WUR signal while it effectively only occupies 4.5 MHz, the UHR data 905 using the OFDM signal are also packed around the WUR signals 910 to utilize the remaining spectrum.

In one method, the AP may allocate RUs across the 20 MHz, 40 MHz, 80 MHz, 160 MHz, or 320 MHz bandwidth to multiple WUR OOK signals and multiple UHR OFDM signals at the same time while balancing the spectral efficiency and the mutual power leakage between the signals. FIG. 10 illustrates an example of RU allocation in a 20 MHz subchannel aggregating WUR signals, which occupy the middle RUs 1001, with UHR PPDU that occupy the remaining RUs outside of the box 1001. In one 20 MHz example, as shown in the example of FIG. 10, the AP may allocate the three middle 26-tone RUs to WUR signals while allocating the remaining six 26-tone RUs to UHR signals; the three middle 26-tone RUs cover 4.5 MHz required by the WUR OOK signals plus guard bands to mitigate the WUR OOK signal leakage to the UHR OFDM signals. That is, if the 26-tone RUs are indexed from left to right as RU26-1, RU26-2, . . . , to RU26-9, RU26-4/5/6 are allocated to WUR signals and RU26-1/2/3 and RU26-7/8/9 may be allocated to UHR OFDM signals. In another example, the AP may allocate RU52-1 (combining RU26-1 and RU26-2), RU26-3, RU26-7, and RU52-4 (combining RU26-8 and RU26-9) to UHR signals. In yet another example, the AP may allocate RUs close to the edge of the subchannels, for example RU26-7/8/9 in a 20 MHz subchannel, to the WUR signals for better leakage management.

In yet another method, in addition to careful RU allocation management, to minimize the power leakage from the WUR OOK signals to the UHR OFDM signals, OOK signal waveforms may be modified to be orthogonal to the OFDM signals in the frequency domain.

To further manage the interference from EHT/UHR-like OFDM signals allocated to the RUs adjacent to, or nearby, WUR signals, the AP may choose a reduced transmit (Tx) power level for those OFDM signals and a lower MCS level for the same coverage range as the one with the normal Tx power. The acceptable power level from the adjacent OFDM signals may be determined by the filtering capability of the WUR receiver, which may be signaled during the association phase of the STA or exchanged before the transmission of the A-PPDU. The interference may also be managed by boosting the WUR signal power, i.e., using higher power than the adjacent OFDM signals. The level of power boosting may also depend on the filtering capability of the WUR receiver, which may be signaled during the association phase of the STA or exchanged before the transmission of the A-PPDU.

Some example embodiments may provide procedures for urgent wake-up and low latency traffic. For example, in some scenarios, the traffic to some WUR STAs may be so urgent that it warrants some special procedures for urgent wake-up and data transmission.

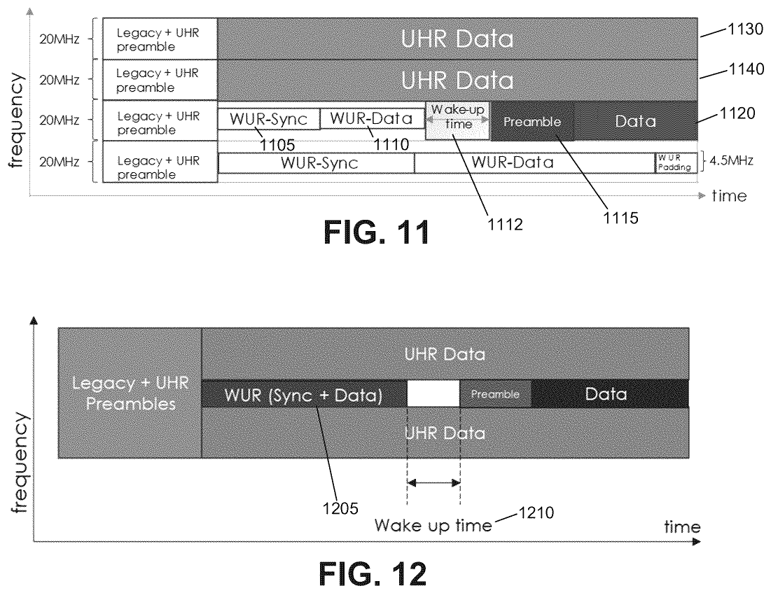

FIG. 11 illustrates an example of aggregating WUR signals with UHR PPDUs, where a WUR signal is followed by urgent traffic data for the MR of the WUR STA in the same 20 MHz subchannel, according to an embodiment. In one example, as shown in FIG. 11, one WUR signal, which may include WUR-Sync 1105 and WUR-Data 1110 in a 20 MHz subchannel (the third one from the top), is received by the WUR receiver of one WUR STA and it is used to wake up the MR of the WUR STA. After the wake-up time 1112 that may be needed for the MR to come out of sleep or deep sleep mode, the WUR AP sends (e.g., immediately sends) a Preamble 1115 and then Data 1120 to the MR in the same 20 MHz subchannel. The preamble 1115 plus data 1120 may be a PPDU in any applicable 802.11 OFDM PPDU format in this 20 MHz subchannel. Note that during the wake-up time 1112, the AP may transmit some filler signals or padding, such as WUR padding signals, to keep the medium busy in the 20 MHz subchannel and avoid other STAs grabbing the subchannel. Also note that to be orthogonal in the frequency domain to concurrent UHR OFDM signals 1130, 1140 in other 20 MHz subchannels, e.g., the top two 20 MHz subchannels shown in FIG. 11, the cyclic prefix and symbol boundaries of the OFDM signals used in Preamble+Data may need be consistent with those used by the concurrent UHR OFDM signals.

The abovementioned transmission from the AP to the WUR receiver and the WUR MR may happen in a 20 MHz subchannel while the concurrent transmission of the UHR data and/or WUR signals to other users happens in other 20 MHz subchannels at the same time, and the transmissions in the subchannels (e.g., all the subchannels) end at the same time, which calls for padding if any subchannel transmission may have a shorter duration than others.

FIG. 12 illustrates another example of aggregating WUR signals with UHR PPDUs, where a WUR signal is followed by urgent traffic data for the MR of the WUR STA in the same RUs, according to an embodiment. In this example, as shown in FIG. 12, one WUR signal 1205, e.g., including WUR-Sync and WUR-Data, in certain middle RUs is transmitted by the WUR AP to wake up the MR of a WUR STA. Similar operations in the 20 MHz subchannel example of FIG. 11 may apply in the example of FIG. 12, except that the WUR STA related transmission happens in a smaller frequency granularity in terms of RUs. Note that in this example, during the wake-up time 1210 for the MR to come out of the sleep or deep sleep mode, the AP may or may not send filler signals or padding to occupy the middle RUs since carrier sensing is done in 20 MHz or higher channels.

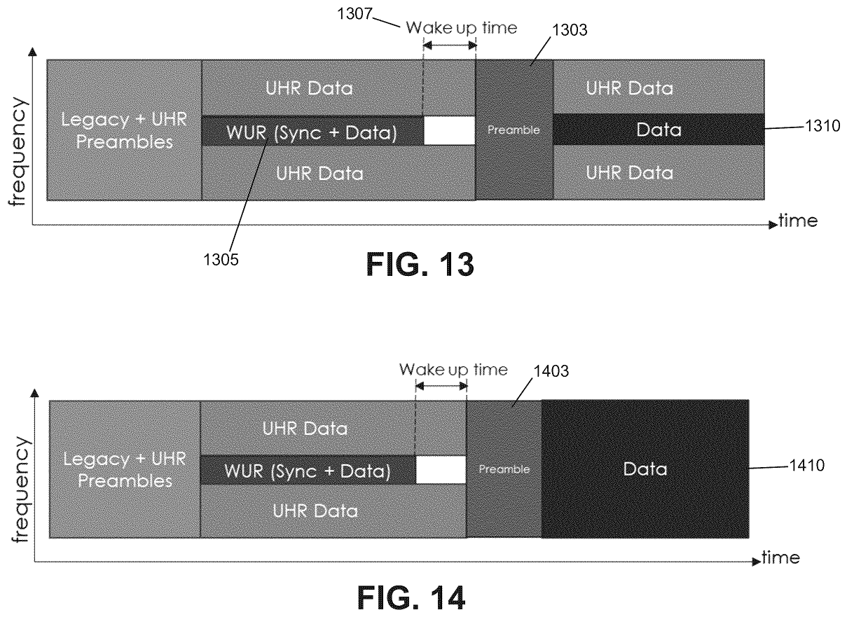

FIG. 13 illustrates an example of aggregating WUR signals with UHR PPDUs, according to an embodiment. In the example of FIG. 13, a second preamble 1303 is inserted across the subchannel and then the urgent traffic data for the MR of the WUR STA may be transmitted in the same RUs as occupied by the WUR signals, according to an embodiment. As shown in the example of FIG. 13, one WUR signal 1305 (e.g., including WUR-Sync+WUR-Data) in certain middle RUs is transmitted by the WUR AP to wake up the MR of a WUR STA. After the wake-up time 1307 (e.g., immediately after the wake-up time) scheduled for the MR to become active in receiving mode, the AP may stop the ongoing UHR data transmission and insert a preamble 1303 before resuming both UHR data transmission and the new data transmission 1310 for the MR in their previous respective RUs. This preamble 1303 may be a full UHR preamble, or a simplified version to just contain necessary fields for the MR to tune automatic gain control (AGC), to do timing/frequency synchronization, and to obtain critical information to receive the urgent traffic data that follow in the assigned middle RUs. In addition, the AP may signal, to the UHR Data users, e.g., in a SIG field, the insertion of the Preamble 1303 that happens before resuming UHR Data transmission in the same RUs.

FIG. 14 illustrates another example of aggregating WUR signals with UHR PPDUs, according to an embodiment. As shown in the example of FIG. 14, a second preamble 1403 is inserted across the subchannel and then the urgent traffic data 1410 for the MR of the WUR STA may be transmitted in the whole subchannel. Thus, in this example, after the preamble 1403, the whole subchannel is assigned to the urgent traffic data 1410 to the woken MR.

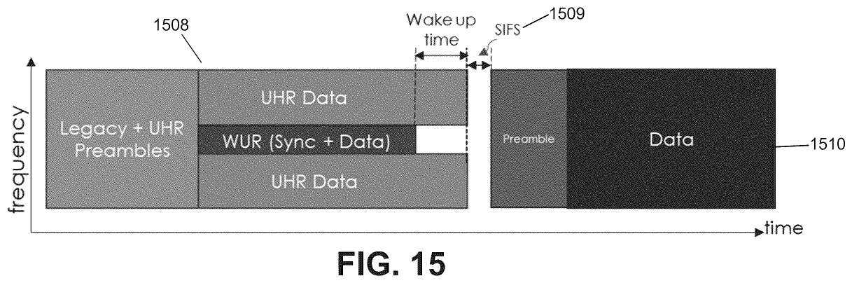

FIG. 15 illustrates an example of aggregating WUR signals with UHR PPDUs, according to another embodiment. In the example of FIG. 15, a second PPDU with the urgent traffic data 1510 for the MR of the WUR STA may be transmitted in the whole subchannel after a short inter-frame spacing (SIFS) time slot 1509 after the first A-PPDU 1508. As illustrated in the example of FIG. 15, the scenario may be similar to what is shown in the example of FIG. 14 but the SIFS slot 1509 is inserted before transmitting the urgent data traffic 1510 in an independent PPDU to the MR of the WUR STA. In this case, SIFS 1509 can ensure that the urgent traffic PPDU is received by the MR of the WUR STA with minimum delay without additional signaling about the second PPDU in the WUR frame.

For the WUR MR in the above examples to know where and how to receive urgent traffic data after waking up, additional signaling may be added to the WUR frame preceding the wake-up time. In one method, the subchannel/RU assignments for the urgent data traffic PPDU may be explicitly signaled in a field of the preceding WUR frame. In another method, the additional signaling may be a mode index. For example, Mode 0 may be defined for the scenario shown in FIG. 11, where the MR is immediately active to receive in the same 20 MHz subchannel; Mode 1 may be defined for the scenario shown in FIG. 12, where the MR is immediately active to detect the preamble and receive data in the same RUs as used by the preceding WUR signals; Mode 2 may be defined for the scenario shown in FIG. 13, where the MR is immediately active to detect the preamble that spans the whole 20 MHz subchannel but then receive data in the same RUs as the WUR signals; Mode 3 may be defined for the scenario shown in FIG. 14, where the MR is immediately active to detect the preamble and then receive data both in the whole 20 MHz subchannel where the WUR signals were sent; and so on. The mode index may reuse some reserved bits in the existing WUR frame types, or a new WUR frame type with the mode index signaled in one of its fields may be defined for urgent wake-up and receiving procedures.

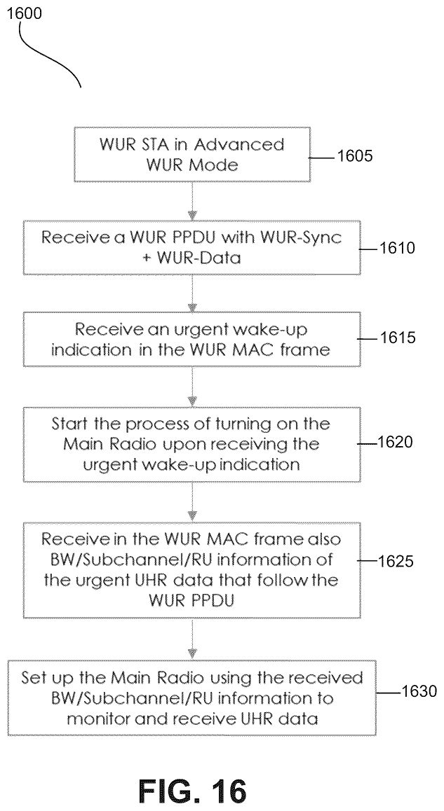

FIG. 16 illustrates an example flow chart of a procedure 1600, which may be implemented by a STA, for receiving urgent wake-up and traffic data, according to one example embodiment. As illustrated in the example of FIG. 16, at 1605, the WUR STA may be in advanced WUR mode or a similar mode. The procedure 1600 may include, at 1610, receiving a WUR PPDU with WUR-Sync and WUR-Data (e.g., a WUR signal including WUR-Sync+WUR-Data). At 1615, the procedure 1600 may include receiving an urgent wake-up indication in the WUR MAC frame. At 1620, the procedure 1600 may include starting the process of turning on the main radio upon receiving the urgent wake-up indication. At 1625, the procedure 1600 may include receiving in the WUR MAC frame also BW, subchannel and/or RU information of the urgent UHR data that follow the WUR PPDU. At 1630, the procedure 1600 may include setting up the main radio using the received BW, subchannel and/or RU information to monitor and receive UHR data.

According to some example embodiments, to enable the concurrent transmission of WUR signal(s) and other non-WUR 802.11 signals in an A-PPDU format as described above, parameter exchange and setup relating to the WUR capabilities of the AP and STAs may be performed (e.g., performed before the concurrent transmission of WUR signal(s) and other non-WUR signals in an A-PPDU). The mechanisms and signal(s) disclosed herein may be used to address one or more of the problems introduced above.

Certain embodiments may provide for an enhanced WUR capabilities exchange. In an embodiment, AP and non-AP STAs may exchange the WUR Capabilities element in the association phase. For example, they may include the WUR Capabilities element in the Probe Request/Response frame, the (Re)Association Request/Response frame, etc. The WUR Capabilities element may be exchanged over a normal primary Wi-Fi radio, e.g., a UHR/UHR+ radio. The WUR Capabilities element may be carried by a Beacon frame and/or an Action frame.

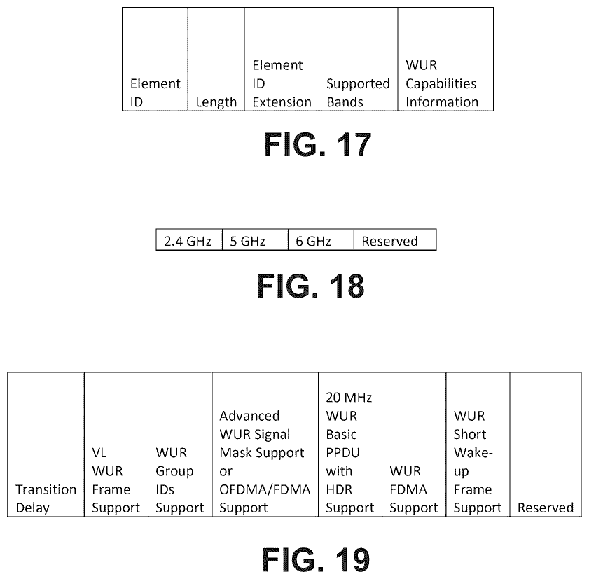

The WUR Capabilities element may indicate a STA's capabilities to support WUR signals. The existing WUR Capabilities element may be modified to support concurrent WUR and non-WUR Wi-Fi signals. For example, FIG. 17 illustrates an example WUR Capabilities element that may have a similar format of that defined in IEEE P802.11-REVme™/D5.0, Wireless LAN Medium Access Control (MAC) and Physical Layer (PHY) Specifications, February 2024 [3]. As shown in FIG. 17, the WUR Capabilities element may include an Element ID, Length, Element ID extension, Supported Bands, and WUR capabilities information fields.

FIG. 18 illustrates an example of a modified Supported Bands field in the WUR capabilities element. The Supported Bands field in the WUR Capabilities element may be modified by adding more operation bands, e.g., 6 GHz band as shown in FIG. 18. The 6 GHz subfield of the Supported Bands field may be set to 1 to indicate the support of the 6 GHz band for the WUR operation.

FIG. 19 illustrates an example modified WUR Capabilities Information field format. The Transition Delay field, Variable Length (VL) WUR Frame Support field, WUR Group IDs Support field, 20 MHz WUR Basic PPDU with HDR Support field, WUR FDMA Support field, and WUR Short Wake-up Frame Support field are defined in IEEE P802.11-REVme™/D5.0, Wireless LAN Medium Access Control (MAC) and Physical Layer (PHY) Specifications, February 2024 [3].

The Advanced WUR Signal Mask Support field or the OFDMA/FDMA Support field may indicate if the advanced WUR Signal Mask is supported and thus OFDMA/FDMA transmission within a 20 MHz channel is supported. Here, the OFDMA/FDMA transmission may refer to a multiple user transmission where one or more users may transmit/receive with WUR signals and one or more users may transmit/receive with non-WUR signals (e.g., UHR/UHR+ signals). In other words, the aggregated PPDU (A-PPDU) is used for OFDMA/FDMA transmission, where the A-PPDU may contain WUR PPDU(s) and non-WUR PPDU(s). In one embodiment, two or more WUR transmit spectrum masks may be defined. The first WUR transmit spectrum mask may be as defined in IEEE P802.11-REVme™/D5.0, Wireless LAN Medium Access Control (MAC) and Physical Layer (PHY) Specifications, February 2024 [3]. Additional WUR transmit spectrum mask(s) may be defined with different separation between the power spectrum density of the desired tones/frequency bandwidth (frequency tones used for WUR signal transmission) and that of the unused tones. For example, a second mask may have higher separation between the maximum spectral density of the signal (i.e., on the desired frequence tones) and the spectral density of the signal on the undesired frequency tones such that the power leakage/interference to the undesired frequency tones may be below certain thresholds and the undesired frequency tones of the WUR signal may be reused by other Wi-Fi signals (e.g., UHR/UHR+ signals), and thus OFDMA/FDMA transmission/reception may be possible.

For a WUR AP, the Advanced WUR Signal Mask Support field (or the OFDMA/FDMA Support field) may be set to 0 if only the first WUR transmission mask may be met by the WUR transmitter (i.e., the WUR AP); otherwise, it may be set to 1. For a WUR STA, the Advanced WUR Signal Mask Support field (or the OFDMA/FDMA Support field) may be set to 0 to indicate that the STA may not be able to detect WUR signals if they are concurrent with other Wi-Fi signals (e.g. non-WUR signals and/or WUR signals) in the same 20 MHz channel/subchannel. The abovementioned new field may be extended to multiple bits to specify a choice from multiple WUR transmit spectrum masks.

In another embodiment, the new field may directly indicate the tolerable interference level of the WUR receiver of a WUR STA, e.g., the maximum interference level or the minimum signal to interference and noise ratio (SINR) under which the WUR receiver can achieve a 10% WUR packet error rate (PER). It is noted that herein the new subfield may be referred to as Advanced WUR Signal Mask Support field or OFDMA/FDMA Support field. However, other names or labels may be used, for example, A-PPDU Support field, etc.

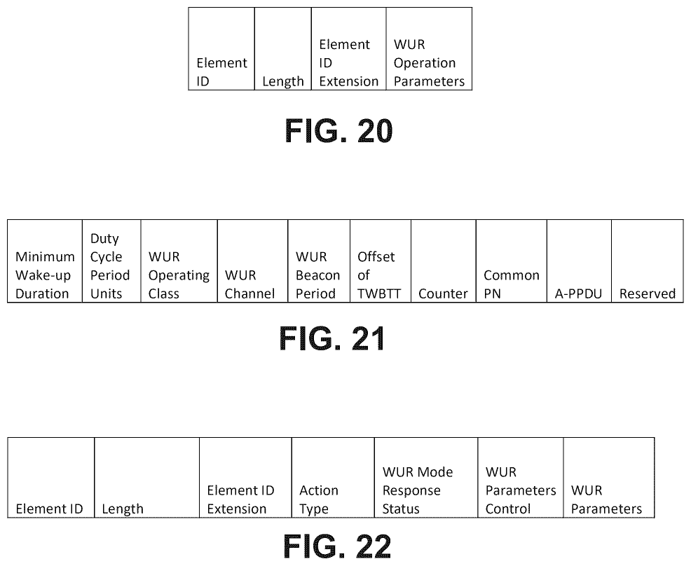

According to an embodiment, the WUR Operation element is exchanged between STAs to indicate the WUR operations on the WUR channels. The WUR Operation element may be carried by a Beacon frame and/or an Action frame, for example. The WUR Operation element may be exchanged over a normal primary Wi-Fi radio, e.g., a UHR/UHR+ radio. An existing WUR Operation element may be modified to indicate that the A-PPDU transmission, which includes at least one WUR signal, may be supported. FIG. 20 illustrates an example of the WUR operation element.

The WUR Operation Parameters field may be modified by adding an A-PPDU subfield as shown in FIG. 21. The A-PPDU subfield may be set to 1 to indicate that A-PPDU transmission may be used for transmitting WUR Wake-up frames, WUR Short Wake-up frames, WUR Beacon frames, WUR Discovery frames, WUR Vender Specific frames, or any other new WUR frames that may not have already been defined.

Some example embodiments may provide an enhanced WUR Mode. The WUR Mode element is exchanged between STAs to negotiate the parameters related to the WUR operation.

The WUR Mode element may be exchanged over a normal primary Wi-Fi radio, e.g., a UHR/UHR+ radio. The existing WUR Mode element may be modified to indicate that the A-PPDU transmission, which includes at least one WUR signal, may be supported. For example, the existing WUR Mode element may be modified to indicate more WUR channels given that the UHR/UHR+ radio may support wider channel bandwidths than 80 MHz. FIG. 22 shows the WUR Mode element format. According to an embodiment, the WUR Parameters Control field and WUR Parameters field may be modified.

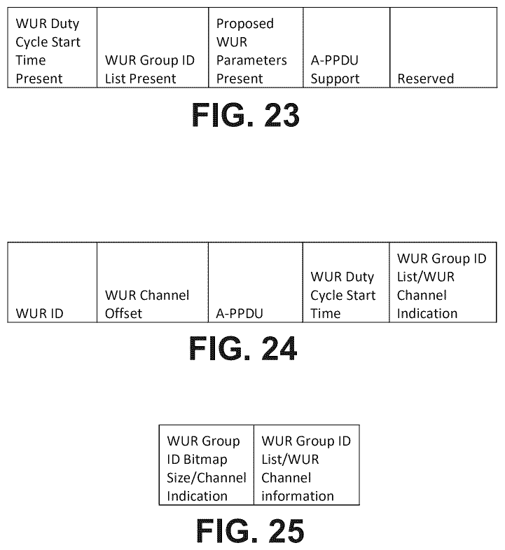

In one embodiment, the modified WUR Parameters Control field may be given as shown in FIG. 23. The WUR Group ID List Present field may be set to 1 to indicate the presence of the WUR Group ID/WUR Channel Indication field. The A-PPDU Support field may indicate that WUR transmission may be carried in an A-PPDU, which may carry other type of PPDU(s) such as UHR/UHR+ PPDU(s).

In one embodiment, the modified WUR Parameters field may be given as shown in FIG. 24. The A-PPDU field may indicate that WUR transmission may be carried in an A-PPDU, which may carry other type of PPDU(s) such as UHR/UHR+ PPDU(s).

In an embodiment, the WUR Group ID List/WUR Channel Indication subfield may be present, and the format of the subfield may be as shown in FIG. 25.

The WUR Group ID Bitmap Size/Channel Indication subfield may be defined as shown in TABLE 1 below. If the value of the WUR Group ID Bitmap Size/Channel Indication subfield is less than 4, it may be used to indicate the WUR Group ID bitmap size. If the value of the WUR Group ID Bitmap Size/Channel Indication subfield is set to a specific value greater than 3 (e.g., 15 as shown in TABLE 1), it may be used to indicate that the WUR Group ID Bitmap Size/Channel Indication subfield may carry full or partial WUR channel information. The WUR channel is defined as a channel that may carry the WUR Wake-up frames, WUR Short Wake-up frames, WUR Vender Specific frames, WUR Beacon frames, WUR Discovery frames, or other new WUR frames to be defined in the future. An AP and a non-AP STA may exchange the WUR Mode element to negotiate the WUR channel for the non-AP STA while the AP may support operations on more than one WUR channels using FDMA or A-PPDU.

If the WUR PPDUs or the A-PPDUs which carries the WUR signal are operating with bandwidth smaller than and/or equal to 80 MHz, the WUR Group ID Bitmap Size/Channel Indication subfield may not be present or set to a value smaller than 4. And the WUR Channel Offset subfield in the WUR Parameters field in the WUR Mode element is used to indicate the negotiated WUR channel for the non-AP STA.

If the WUR PPDUs or the A-PPDUs that carry WUR signals are operating with a bandwidth greater than 80 MHz, the WUR Group ID Bitmap Size/Channel Indication subfield may be present and/or set to a specific value greater than 4 (e.g., 15 as shown in TABLE 1). And the WUR Channel Offset subfield in the WUR Parameters field in the WUR Mode element and/or the WUR Group ID Bitmap/WUR Channel Information subfield is used to indicate the negotiated WUR channel for the non-AP STA.

TABLE 1
Meaning of the WUR Group ID Bitmap
Size/Channel Indication subfield

| WUR Group ID Bitmap | |
|---|---|
| Size/Channel Indication | Meaning |
| 0 | WUR Group ID Bitmap field is not present |
| 1 | WUR Group ID List/WUR Channel |
| | Information subfield may carry the WUR |
| | Group ID Bitmap and the WUR Group ID |
| | Bitmap contains a 16-bit bitmap |
| 2 | WUR Group ID List/WUR Channel |
| | Information subfield may carry the WUR |
| | Group ID Bitmap and the WUR Group ID |
| | Bitmap contains a 32-bit bitmap |
| 3 | WUR Group ID List/WUR Channel |
| | Information subfield may carry the WUR |
| | Group ID Bitmap and the WUR Group ID |
| | Bitmap contains a 64-bit bitmap |
| 4-14 | Reserved |
| 15 | The WUR Group ID List/WUR Channel |
| | Information subfield may carry WUR Channel |
| | information |

In one embodiment, the WUR Channel Information subfield may be a self-contained subfield. In other words, the WUR Channel Information subfield may indicate the 20 MHz subchannel within a x MHz channel that may carry WUR signals. Here, x may be greater than 80 MHz, e.g., 160 MHz, 320 MHz etc. In one example, a WUR Channel Information subfield with a value of n may indicate the (n+1)th 20 MHz subchannel from the lowest/highest frequency, where n=0, . . . , N−1. N may be 8 if the bandwidth is 160 MHz, and 16 if the bandwidth is 320 MHz. The size of the subfield may depend on the maximum bandwidth supported. For example, if K MHz is the maximum bandwidth, then the size of the subfield may be [log 2(K/20)].

In one embodiment, the WUR Channel Information subfield may be an extended subfield to the WUR Channel Offset subfield. In other words, the WUR Channel Information subfield and the WUR Channel Offset subfield together may indicate the 20 MHz subchannel within a x MHz channel that may carry the WUR signal. Here, x may be greater than 80 MHz, e.g., 160 MHz, 320 MHz, etc. For example, the WUR Channel Information subfield may indicate the 80 MHz subchannel that contains the WUR signal, while the WUR Channel Offset subfield may indicate the 20 MHz subchannel within the 80 MHz subchannel that contains the WUR signal.

In an embodiment, a new WUR action frame may be defined and carry the A-PPDU field, 6 GHz Support field, and WUR Channel Indication field to enable WUR coexistence with wideband transmissions, such as UHR/UHR+ WiFi signals.

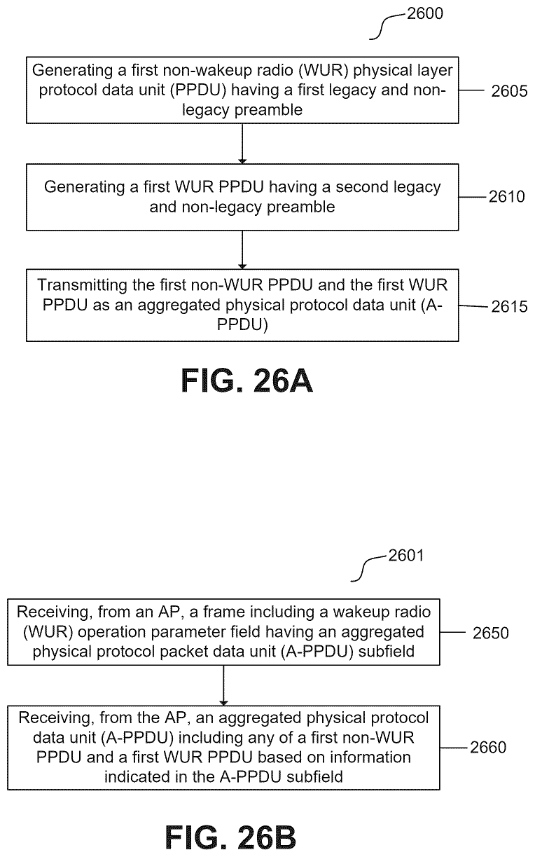

FIG. 26A is an example flow diagram illustrating an example method 2600 relating to the operation of A-PPDU with WUR signals in Wi-Fi, according to an embodiment. The example method of FIG. 26A and accompanying disclosures herein may be considered an application, generalization and/or synthetization of the various disclosures discussed above. For convenience and simplicity of exposition, the example of FIG. 26A may be described with reference to the architecture or system described above with respect to FIGS. 1A-1D and/or FIG. 2, for instance. However, the example method depicted in FIG. 26A may be carried out using different architectures as well. According to some embodiments, the method of FIG. 26A may be implemented by an AP, such as AP 202 described in reference to FIG. 2. Further, the method of FIG. 26A may be modified to include any of the steps, procedures, portions of procedures and/or details illustrated in the other flow diagrams described herein. Moreover, it is noted that the method and/or blocks of FIG. 26A may be modified to include, or to be replaced by, any one or more of the procedures or blocks discussed elsewhere herein. As such, one of ordinary skill in the art would understand that FIG. 26A is provided as one example and modifications thereto are possible while remaining within the scope of certain example embodiments.

As illustrated in the example of FIG. 26A, the method 2600 may include, at 2605, generating a first non-wakeup radio (WUR) physical layer protocol data unit (PPDU) having a first legacy and non-legacy preamble. In an embodiment, the method 2600 may include, at 2610, generating a first WUR PPDU having a second legacy and non-legacy preamble. According to an embodiment, the method 2600 may include, at 2615, transmitting the first non-WUR PPDU and the first WUR PPDU as an aggregated physical protocol data unit (A-PPDU). For instance, in one example, the transmitting at 2615 may include transmitting the A-PPDU to one or more STAs. In one example embodiment, the non-WUR PPDU and WUR PPDU may be intended for different STAs. In another example embodiment, the non-WUR PPDU and WUR PPDU may be intended for the same STA.

In some embodiments, the method 2600 may include generating a second non-WUR PPDU having a third legacy and non-legacy preamble, generating a second WUR PPDU having a fourth legacy and non-legacy preamble, and transmitting, for example to one or more STAs, the second non-WUR PPDU and the second WUR PPDU within the A-PPDU.

According to one example, the first legacy and non-legacy preamble and the second legacy and non-legacy preamble are the same. In another example, the first legacy and non-legacy preamble and the second legacy and non-legacy preamble are different.

In an embodiment, the first non-WUR PPDU occupies a first subchannel and the first WUR PPDU occupies a second subchannel of the A-PPDU.

According to an embodiment, the first subchannel may include any of a 20 MHz subchannel, a 40 MHz subchannel, a 60 MHz subchannel, and an 80 MHz subchannel. In an embodiment, the second subchannel may include any of a 20 MHz subchannel, a 40 MHz subchannel, a 60 MHz subchannel, and an 80 MHz subchannel.

According to an embodiment, the first non-WUR PPDU and the first WUR PPDU occupy a same subchannel, and where the same subchannel may include any of a 20 MHz subchannel, a 40 MHz subchannel, a 60 MHz subchannel, and an 80 MHz subchannel.

In some embodiments, the first WUR PPDU may be transmitted based on a first transmit mask to reduce interference between the first WUR PPDU and the first non-WUR PPDU of the A-PPDU.

According to an embodiment, the first non-WUR PPDU may include first UHR data and the first non-legacy preamble comprises a UHR preamble. In an embodiment, the first WUR PPDU may include a first WUR synchronization field and a first WUR data field.

It is noted that the flow diagram illustrated in FIG. 26A is provided as one example, and modifications thereto are contemplated according to certain embodiments as discussed elsewhere herein. For example, one or more of the steps illustrated in FIG. 26A may be omitted, combined, modified and/or performed in a different order, as provided in the example embodiments discussed herein.

FIG. 26B is an example flow diagram illustrating an example method 2601 relating to the operation of A-PPDU with WUR signals in Wi-Fi, according to an embodiment. The example method of FIG. 26B and accompanying disclosures herein may be considered an application, generalization and/or synthetization of the various disclosures discussed above. For convenience and simplicity of exposition, the example of FIG. 26B may be described with reference to the architecture or system described above with respect to FIGS. 1A-1D and/or FIG. 2, for instance. However, the example method depicted in FIG. 26B may be carried out using different architectures as well. According to some embodiments, the method of FIG. 26B may be implemented by a STA, such as one or more of the STAs 208, 210, 212 described in reference to FIG. 2. Further, the method of FIG. 26B may be modified to include any of the steps, procedures, portions of procedures and/or details illustrated in the other flow diagrams described herein. Moreover, it is noted that the method and/or blocks of FIG. 26B may be modified to include, or to be replaced by, any one or more of the procedures or blocks discussed elsewhere herein. As such, one of ordinary skill in the art would understand that FIG. 26B is provided as one example and modifications thereto are possible while remaining within the scope of certain example embodiments.

As illustrated in the example of FIG. 26B, the method 2601 may include, at 2650, receiving, from an AP, a frame including a wakeup radio (WUR) operation parameter field having an aggregated physical protocol packet data unit (A-PPDU) subfield. In an embodiment, the method 2601 may include, at 2660, receiving, from the AP, an aggregated physical protocol data unit (A-PPDU) including any of a first non-WUR PPDU and a first WUR PPDU based on information indicated in the A-PPDU subfield.

According to an example embodiment, the first non-WUR PPDU occupies a first subchannel and the first WUR PPDU occupies a second subchannel of the A-PPDU. For example, the first subchannel may include any one or more of a 20 MHz subchannel, a 40 MHz subchannel, a 60 MHz subchannel, and/or an 80 MHz subchannel (or greater). For example, the second subchannel may include any one or more of a 20 MHz subchannel, a 40 MHz subchannel, a 60 MHz subchannel, and/or an 80 MHz subchannel (or greater).

In one example embodiment, the first non-WUR PPDU and the first WUR PPDU occupy a same subchannel. For instance, the same subchannel may be any one or more of a 20 MHz subchannel, a 40 MHz subchannel, a 60 MHz subchannel, and/or an 80 MHz subchannel (or greater).

In an embodiment, the non-WUR PPDU may include a first legacy and non-legacy preamble and the WUR PPDU may include a second legacy and non-legacy preamble. According to one example, the first legacy and non-legacy preamble and the second legacy and non-legacy preamble are the same. However, according to other examples, the first legacy and non-legacy preamble and the second legacy and non-legacy preamble may be different.

According to some examples, the frame may include one of a beacon frame, an action frame, a probe response frame, an association response frame, or a re-association response frame.

In an embodiment, the wakeup radio (WUR) operation parameter field may further include a supported bands field including a 2.4 GHz subfield indicating a 2.4 GHz band, a 5.0 GHz subfield indicating a 5.0 GHz band, and a 6.0 GHz subfield indicating a 6.0 GHz band.

According to an embodiment, the wakeup radio (WUR) operation parameter field may further include a WUR transmit spectrum mask for reducing interference between on-off keying (OOK) signals associated with the WUR PPDU and OFDM symbols associated with the non-WUR PPDU.

In an embodiment, the wakeup radio (WUR) operation parameter field comprises a WUR channel indication that indicates one or more WUR channels in wideband operation including one of a 160 MHz or 320 MHz bandwidth.

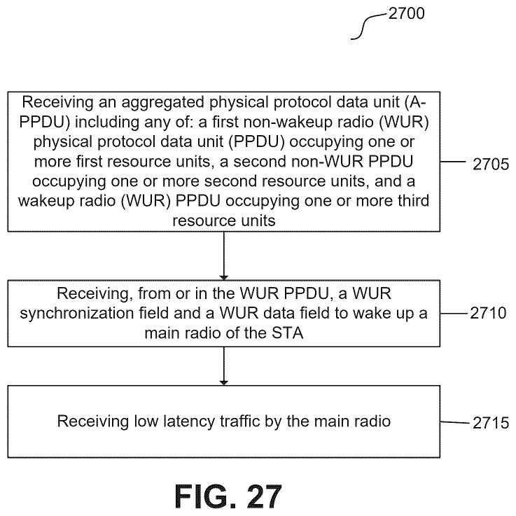

It is noted that the flow diagram illustrated in FIG. 26B is provided as one example, and modifications thereto are contemplated according to certain embodiments as discussed elsewhere herein. For example, one or more of the steps illustrated in FIG. 26B may be omitted, combined, modified and/or performed in a different order, as provided in the example embodiments discussed herein. For instance, one or more of the steps illustrated in FIG. 26B may be combined with and/or modified in view of FIG. 27 discussed below.

FIG. 27 is an example flow diagram illustrating an example method 2700 relating to the operation of ultra-low-latency traffic handling with WUR signals and A-PPDU in Wi-Fi, according to an embodiment. The example method of FIG. 27 and accompanying disclosures herein may be considered an application, generalization and/or synthetization of the various disclosures discussed above. For convenience and simplicity of exposition, the example of FIG. 27 may be described with reference to the architecture or system described above with respect to FIGS. 1A-1D and/or FIG. 2, for instance. However, the example method depicted in FIG. 27 may be carried out using different architectures as well. According to some embodiments, the method of FIG. 27 may be implemented by a STA, such as one or more of the STAs 208, 210, 212 described in reference to FIG. 2. Further, the method of FIG. 27 may be modified to include any of the steps, procedures, portions of procedures and/or details illustrated in the other flow diagrams described herein. Moreover, it is noted that the method and/or blocks of FIG. 27 may be modified to include, or to be replaced by, any one or more of the procedures or blocks discussed elsewhere herein. As such, one of ordinary skill in the art would understand that FIG. 27 is provided as one example and modifications thereto are possible while remaining within the scope of certain example embodiments.

As illustrated in the example of FIG. 27, the method 2700 may include, at 2705, receiving, e.g., from an AP, an aggregated physical protocol data unit (A-PPDU) including any of a first non-wakeup radio (WUR) physical protocol data unit (PPDU) occupying one or more first resource units, a second non-WUR PPDU occupying one or more second resource units, and a wakeup radio (WUR) PPDU occupying one or more third resource units.

According to one example, a same legacy and non-legacy preamble may be used for the first non-WUR PPDU, the second non-WUR PPDU, and the WUR PPDU. However, in other embodiments, a different legacy and non-legacy preamble may be used for the first non-WUR PPDU, the second non-WUR PPDU, and the WUR PPDU.

In some embodiments, the first non-WUR PPDU may occupying the one or more first resource units is within a first 20 MHz subchannel, the second non-WUR PPDU occupying the one or more second resource units is within a second 20 MHz subchannel, and the WUR PPDU occupying the one or more third resource units is within a third 20 MHz subchannel, where the first, the second, and the third subchannels may be adjacent.

According to an embodiment, the one or more third resource units of the WUR PPDU may be located between and adjacent to the one or more first resource units of the first non-WUR PPDU and the one or more second resource units of the second non-WUR PPDU, where the one or more first, second, and third resource units are within a 20 MHz subchannel.

In an embodiment, the method 2700 may include, at 2710, receiving, from or in the WUR PPDU, a WUR synchronization field and a WUR data field to wake up a main radio of the STA. According to one embodiment, the WUR PPDU may include a wake-up period following the WUR data field for enabling the main radio to come out of a sleep mode.

According to one example, the wake-up period may include or may be a padding (e.g., padding portion(s), padding signal(s), padding symbol(s) or the like) to provide time for the STA to transition from a WUR radio to the main radio while occupying the medium.

In an embodiment, the method 2700 may include, at 2715, receiving, e.g., from the AP, low latency traffic by the main radio. According to one example, the low latency traffic may be transmitted and/or received using the entire third 20 MHz subchannel and the WUR PPDU is transmitted within the same third 20 MHz subchannel using a portion of the third 20 MHz subchannel. According to an example, the low latency traffic and the WUR PPDU are transmitted and/or received using the one or more third resource units.

According to some embodiments, the receiving of the low latency traffic, at 2715, may include receiving an ultra high reliability (UHR) preamble following the wake-up period, and receiving low latency data associated with the low latency traffic following the UHR preamble. In an embodiment, the UHR preamble may occupy an entire 20 MHz comprising the first and the second non-WUR PPDU and the WUR PPDU.

It is noted that the flow diagram illustrated in FIG. 27 is provided as one example, and modifications thereto are contemplated according to certain embodiments as discussed elsewhere herein. For example, one or more of the steps illustrated in FIG. 27 may be omitted, combined, modified and/or performed in a different order, as provided in the example embodiments discussed herein.

As discussed in detail above, according to some example embodiments, a WUR AP may transmit A-PPDUs that aggregate WUR signals with other WUR or non-WUR 802.11 signals, e.g., 802.11bn signals or 802.11bn+ signals, in both frequency and time domains. In an embodiment, an A-PPDU can occupy a bandwidth of 20 MHz, 40 MHz, 80 MHz, 160 MHz, or 320 MHz. In an embodiment, each 20 MHz subchannel may be dedicated to one WUR signal, or multiple WUR signals both in time and frequency. In an embodiment, each 20 MHz subchannel may assign some RUs to WUR signals while remaining RUs to carry other non-WUR 802.11 signals.

As also discussed in detail above, in some embodiments, a WUR AP and non-AP STAs in a BSS exchange WUR-related information through the enhanced WUR capabilities element, the enhanced WUR operation element, and the enhanced WUR mode element in Beacom frames, Probe Request/Response frames, (Re)Association Request/Response frames, and/or Action frames. In an embodiment, the new enhanced WUR information includes more supported WUR bands, advanced spectrum mask support, WUR A-PPDU operation support, WUR channel/RU indication, interference tolerance level, etc. The frequency and time resource assignment of WUR A-PPDUs are determined by the AP according to WUR information exchanged between the WUR AP and non-AP STAs.

As discussed in detail above, a special procedure for urgent wake-up and low-latency traffic may be provided or implemented by a WUR AP and/or a WUR STA. In an embodiment, the WUR AP may send an A-PPDU that carries a WUR PPDU to be received by the WUR receiver of the WUR STA and then a non-WUR low-latency traffic PPDU that immediately follows to be received by the main radio of the WUR STA. In an embodiment, the WUR PPDU carries a WUR MAC frame that contains an urgent wake-up indication and the BW/subchannel/RU assignment of the low-latency traffic PPDU that follows the WUR PPDU. In an embodiment, the WUR receiver of the WUR STA receives a WUR PPDU with urgent wake-up indication and wakes up the main radio; the WUR receiver also receives the BW/subchannel/RU assignment of the urgent traffic that sets up the main radio to monitor and receive the low-latency traffic PPDU.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In some example embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Any characteristic, variant or embodiment described for a method is compatible with an apparatus device comprising means for processing the disclosed method, such as with a device comprising a processor configured to process the disclosed method, a computer program product comprising program code instructions and a non-transitory computer-readable storage medium storing program instructions.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Although various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although some example embodiments are illustrated and described herein, the invention is not intended to just be limited to the details shown. Rather, various modifications and variations may be made in the details within the scope and range of equivalents of the claims and without departing from the spirit or scope invention.

### REFERENCES

The following references may have been referred to hereinabove, each of which is incorporated herein by reference in its entirety.
[1] IEEE Std 802.11™-2020: Wireless LAN Medium Access Control (MAC) and Physical Layer (PHY) Specifications;
[2] IEEE P802.11ax™/D8.0: Wireless LAN Medium Access Control (MAC) and Physical Layer (PHY) Specifications;
[3] IEEE P802.11-REVme™/D5.0: Wireless LAN Medium Access Control (MAC) and Physical Layer (PHY) Specifications, February 2024;
[4] IEEE 802.11-16/1045r9, “A PAR Proposal for Wake-up Radio,” Jul. 2016.

What is claimed is:

1. An Access Point (AP), comprising:
a transceiver; and
a processor,
wherein the transceiver and processor are configured to:
generate a first non-wakeup radio (WUR) physical layer protocol data unit (PPDU) having a first legacy and non-legacy preamble;
generate a first WUR PPDU having a second legacy and non-legacy preamble; and
transmit the first non-WUR PPDU and the first WUR PPDU as an aggregated physical protocol data unit (A-PPDU).

2. The AP of claim 1, wherein the transceiver and processor are further configured to:
generate a second non-WUR PPDU having a third legacy and non-legacy preamble;
generate a second WUR PPDU having a fourth legacy and non-legacy preamble;
transmit the second non-WUR PPDU and the second WUR PPDU within the A-PPDU.

3. The AP of claim 1, wherein, the first legacy and non-legacy preamble and the second legacy and non-legacy preamble are the same.

4. The AP of claim 1, wherein the first legacy and non-legacy preamble and the second legacy and non-legacy preamble are different.

5. The AP of claim 1, wherein the first non-WUR PPDU occupies a first subchannel and the first WUR PPDU occupies a second subchannel of the A-PPDU.

6. The AP of claim 5, wherein:
the first subchannel comprises any of a 20 MHz subchannel, a 40 MHz subchannel, a 60 MHz subchannel, and an 80 MHz subchannel; and
the second subchannel comprises any of a 20 MHz subchannel, a 40 MHz subchannel, a 60 MHz subchannel, and an 80 MHz subchannel.

7. The AP of claim 1, wherein the first non-WUR PPDU and the first WUR PPDU occupy a same subchannel, and wherein the same subchannel comprises any of a 20 MHz subchannel, a 40 MHz subchannel, a 60 MHz subchannel, and an 80 MHz subchannel.

8. The AP of claim 1, wherein the first WUR PPDU is transmitted based on a first transmit mask to reduce interference between the first WUR PPDU and the first non-WUR PPDU of the A-PPDU.

9. The AP of claim 1, wherein the first non-WUR PPDU comprises first UHR data and the first non-legacy preamble comprises a UHR preamble.

10. The AP of claim 1, wherein the first WUR PPDU comprises a first WUR synchronization field and a first WUR data field.

11. A Station (STA), comprising:
a transceiver; and
a processor,
wherein the transceiver and processor are configured to:
receive, from an access point (AP), a frame including a wakeup radio (WUR) operation parameter field having an aggregated physical protocol packet data unit (A-PPDU) subfield; and
receive, from the AP, an aggregated physical protocol data unit (A-PPDU) including any of a first non-WUR PPDU and a first WUR PPDU based on information indicated in the A-PPDU subfield.

12. The STA of claim 11, wherein the first non-WUR PPDU occupies a first subchannel and the first WUR PPDU occupies a second subchannel of the A-PPDU.

13. The STA of claim 12, wherein:
the first subchannel comprises any of a 20 MHz subchannel, a 40 MHz subchannel, a 60 MHz subchannel, and an 80 MHz subchannel; and
the second subchannel comprises any of a 20 MHz subchannel, a 40 MHz subchannel, a 60 MHz subchannel, and an 80 MHz subchannel.

14. The STA of claim 11, wherein the first non-WUR PPDU and the first WUR PPDU occupy a same subchannel, and wherein the same subchannel comprises any of a 20 MHz subchannel, a 40 MHz subchannel, a 60 MHz subchannel, and an 80 MHz subchannel.

15. The STA of claim 11, wherein the non-WUR PPDU comprises a first legacy and non-legacy preamble and the WUR PPDU comprises a second legacy and non-legacy preamble.

16. The STA of claim 15, wherein the first legacy and non-legacy preamble and the second legacy and non-legacy preamble are the same.

17. The STA of claim 11, wherein the frame comprises one of a beacon frame, an action frame, a probe response frame, an association response frame, or a re-association response frame.

18. The STA of claim 11, wherein the wakeup radio (WUR) operation parameter field further comprises a supported bands field comprising a 2.4 GHz subfield indicating a 2.4 GHz band, a 5.0 GHz subfield indicating a 5.0 GHz band, and a 6.0 GHz subfield indicating a 6.0 GHz band.

19. The STA of claim 11, wherein the wakeup radio (WUR) operation parameter field further comprises a WUR transmit spectrum mask for reducing interference between on-off keying (OOK) signals associated with the WUR PPDU and OFDM symbols associated with the non-WUR PPDU.

20. The STA of claim 11, wherein the wakeup radio (WUR) operation parameter field comprises a WUR channel indication that indicates one or more WUR channels in wideband operation including one of a 160 MHz or 320 MHz bandwidth.

21. A method, comprising:
receiving, from an access point (AP), a frame including a wakeup radio (WUR) operation parameter field having an aggregated physical protocol packet data unit (A-PPDU) subfield; and
receiving, from the AP, an aggregated physical protocol data unit (A-PPDU) including any of a first non-WUR PPDU and a first WUR PPDU based on information indicated in the A-PPDU subfield.
